(19) United States
(12) Patent Application Publication
(10) Pub. No.: US 2020/0043676 A1
(43) Pub. Date: Feb. 6, 2020

(54) ARC CHAMBER FOR A DC CIRCUIT BREAKER

(71) Applicant: ABB Schweiz AG, Baden (CH)

(72) Inventors: Rudolf Gati, Mellingen (CH); Matthias Bator, Klettgau (DE); Osvaldo Prestini, Nembro (IT); Pierluigi Cisana, Paladina BG (IT); Thorsten Strassel, Mülligen (CH)

(21) Appl. No.: 16/600,680

(22) Filed: Oct. 14, 2019

Related U.S. Application Data
(63) Continuation of application No. PCT/EP2018/059534, filed on Apr. 13, 2018.

(30) Foreign Application Priority Data
Apr. 13, 2017 (EP) 17166488.1

(51) Int. Cl. H01H 9/34; H01H 9/36

(52) U.S. Cl. CPC H01H 9/346; H01H 2009/367; H01H 9/341; H01H 9/36

(57) ABSTRACT

An arc chamber for a DC circuit breaker includes an entry side adapted to receive an electric arc, which was generated outside of the arc chamber and which propagates in a forward direction, a plurality of stacked splitter plates, and at least one inhibitor barrier. The at least one inhibitor barrier is arranged on the entry side to inhibit a reverse propagation of the electric arc out of the arc chamber in a reverse direction. DC circuit breaker comprising an arc chamber. Use of an arc chamber with a circuit breaker in a DC electrical system.

### TECHNICAL FIELD

Aspects of the present disclosure relate generally to an arc chamber for a DC circuit breaker, to a DC circuit breaker comprising an arc chamber as disclosed herein, and a use of an arc chamber with a circuit breaker in a DC electrical system.

### BACKGROUND ART

In certain types of circuit breakers, contacts are separated from each other by a mechanical movement, such that an arc is ignited between the contacts. The arc is guided, typically along metallic rails, towards a stacked arrangement of a plurality of splitter plates, which are located inside an arcing chamber filled with a switching medium. The splitter plates are typically arranged substantially in parallel to each other, side by side in a stacking direction, wherein a space is thrilled in between each pair of adjacent splitter plates.

The arc impacts upon the edges of the splitter plates and is split in several arc segments. Ideally, the arc enters the splitter plates, and the arc segments stay within the splitter plate region until the current is interrupted. Then, the arc is extinguished.

Because of electromagnetic interaction among the arc segments, the arc can propagate in a backwards direction, i. e. towards the side where it entered the stack of splitter plates. In this case, the arc is hindered from being extinguished within a reasonable amount of time, which may result in undesired prolongation of the arc extinguishing process.

### SUMMARY OF THE DISCLOSURE

An object of the disclosure is to provide an arc chamber with an improved arc extinguishing capability, particularly allowing to extinguish an arc more reliably even under difficult conditions, while maintaining a low-cost and/or compact design.

In view of the above, an arc chamber for a DC circuit breaker according to claim 1, a DC circuit breaker comprising an arc chamber according to claim 11, and a use of an are chamber with a circuit breaker in a DC electrical system according to claim 12 are provided. According to a first aspect, an arc chamber for a DC circuit breaker is provided. The arc chamber comprises an entry side, a plurality of stacked splitter plates and at least one inhibitor barrier. The entry side is adapted to receive an electric arc which was generated outside of the arc chamber and which propagates in a forward direction. The at least one inhibitor plate is arranged on the entry side and is configured and arranged such as to inhibit a reverse propagation of the electric arc out of the arc chamber in a reverse direction.

According to another aspect of the disclosure, a DC circuit breaker is provided. The DC circuit breaker comprises an arc chamber as described herein. According to yet a further aspect of the disclosure, a use of an arc chamber, as described herein, with a circuit breaker in a DC electrical system is provided.

When the arc enters the chamber on the entry side, it propagates in the forward direction towards the stack, or pile, of splitter plates. Back propagation of the arc which once entered the chamber, i. e. a propagation in the reverse direction, such that the arc eventually leaves the chamber again on the entry side, is suppressed by the arrangement and configuration of the at least one inhibitor plate.

In embodiments, in a top view of the arc chamber, i.e. in a viewing direction along the stacking direction of the splitter plates, the at least one inhibitor barrier is arranged in a corner part on the entry side of the arc chamber. Additionally, the arc chamber may comprise at least two inhibitor barriers, each of which is arranged, in the top view of the chamber, in opposite corner parts on the entry side of the arc chamber. Optionally, when at least two inhibitor barriers are provided in opposite corner parts on the entry side of the arc chamber, the at least two inhibitor barriers may be spaced apart from each other, thus forming a gap for the entry of the electric arc into the region of the stacked splitter plates.

An arc which propagates in the reverse direction often moves, from a central region of the arc chamber, to the corner parts of the chamber. An inhibitor barrier, which is arranged in the corner part on the entry side, optionally one inhibitor plate per different corner part, may help to further improve to prevent the back propagation of the arc more effectively or more selectively. A gap for the entry of the electric arc may help to ensure that the arc may enter the splitter plate region substantially unhindered, while it is effectively prevented to propagate in the reverse direction beyond the corners on the entry side. In embodiments, the at least one inhibitor barrier extends substantially in the stacking direction of the splitter plates. The at least ore inhibitor barrier extending substantially in the stacking direction of the splitter plates may continuously extend essentially from one outermost splitter plate of the stack to the other outermost splitter plate of the stack.

Alternatively, the at least one inhibitor barrier extending substantially in the stacking direction of the splitter plates may be formed of a pile of inhibitor plates which are arranged in an aligned manner in the stacking direction, wherein each inhibitor plate is provided between adjacent ones of the plurality of splitter plates, i.e. between at least one pair of adjacent splitter plates of the plurality of splitter plates. Optionally, a respective inhibitor plate is provided between each of the adjacent ones of the plurality of splitter plates, i.e. between each pair of adjacent splitter plates of the plurality of splitter plates.

In embodiments, the arc chamber comprises an inlet of an exhaust channel in a region of the at least one inhibitor barrier. The region of the at least one inhibitor barrier, where the inlet is provided, is an area, where it is likely that at least a major part of a flow of hot gas, which is generated by the propagating arc, streams into the inlet. The exhaust channel extends to a gas outlet. The gas outlet is formed on a side of the arc chamber, which is different from the entry side. In this way, the hot gas may be effectively guided to a location, where it does not delay or prevent the arc from being extinguished.

Further advantages, features, aspects and details that can be combined as appropriate with embodiments described herein are disclosed in the dependent claims and claim combinations, in the description and in the drawings.

### BRIEF DESCRIPTION OF THE DRAWINGS

The disclosure will be described in greater detail with reference to the accompanying drawings, in which:

FIGS. 1a-1c show a schematic cross-sectional side view of an arc chamber with a schematic representation of different stages of an arc propagating towards a plurality of stacked splitter plates, according to a comparative example;

FIG. 2a shows a schematic cross-sectional side view of an arc chamber comprising inhibitor barriers, according to an embodiment of the invention; and

FIG. 2b shows a schematic cross-sectional top view of the arc chamber of FIG. 2a.

### EMBODIMENTS OF THE DISCLOSURE

Reference will now be made in detail to various aspects and embodiments. Each aspect and embodiment is provided by way of explanation and is not intended as a limitation. Features illustrated or described as a part of one aspect or embodiment may be used in conjunction with any other aspect or embodiment. It is intended that the present disclosure includes such combinations and modifications. In the drawings, same reference numerals refer to same or like parts. For casing the understanding, some reference numerals are omitted in those drawings showing essentially the same structure, at a different point in time, of a preceding drawing.

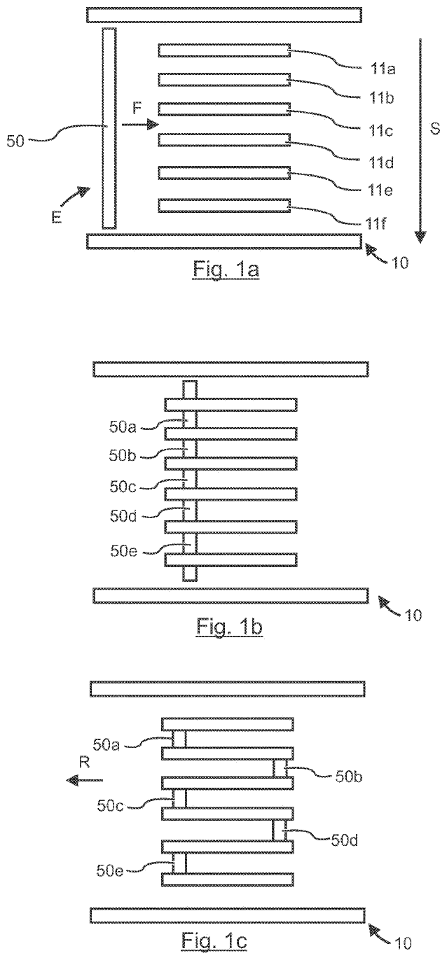

FIGS. 1a-1c show a schematic cross-sectional side view of an arc chamber 10 according to a comparative example for explanatory purposes. In FIGS. 1a-1c, a stack or pile comprises a plurality of splitter plates 11a to 11f which are arranged substantially parallel to each other and at a distance between each pair of adjacent splitter plates 11a-11b, 11b-11c, 11c-11d, 11d-11e, 11e-11f, in a stacking direction S. Typically, the stacking direction S corresponds to an up-down direction of the chamber 10. The number of splitter plates depicted in the drawings is only intended as an example and not to be interpreted as a limitation.

An arc 50 is generated outside of the arc chamber 10, e. g. in between the opening contact elements of a low-voltage or medium-voltage circuit breaker (not shown). The arc is ignited in a space filled with a switching medium. While the arc bums in between the contacts, the arc voltage does not change much. At some point in time, the are detaches from the contacts, bends, and moves, typically along metallic rails known as arc runners, towards the stack of splitter plates 11a-11f.

In FIG. 1a, the arc 50 is still outside the stack and propagates in a forward direction F, until it reaches, i. e. impacts on, the front edges of the splitter plates 11a-11f. The front edges are located on a side of the arc chamber 10 where the arc 50 impacts thereon, and this side of the arc chamber will be referred to as an entry side E herein. The voltage due to the burning arc increases and the arc commutes further into the region of the splitter plates 11a-11f.

In FIG. 1b, after the impact, the arc 50 is split into several segments 50a-50e inside the spaces in between adjacent ones of the splitter plates 11a-11f. A maximum arc voltage is maintained, until the current is interrupted. A cooling effect of the splitter plates 11a-11f may help to extinguish the arc segments 50a-50e and to interrupt the current. The time taken to interrupt the current may be increased, in the comparative example of FIGS. 1a-1c, due to a phenomenon referred to as “back-ignitions” in the following. Preceding a back-ignition, the non-extinguished arc 50 or arc segments 50a-50e propagate in a reverse direction R. An additional delay due to the back-ignition leads to a large amount of energy deposited in the circuit breaker, and hence to an increased wear of the circuit breaker.

In FIG. 1c, a magnetic interaction between the arc segments 50a-50e generates repelling forces, which act on some or all of the arc segments 50a-50e. An asymmetry in the position of the arc segments 50a-50e along the stacking direction S will be enhanced by the repelling forces, leading to a repulsion of the arc segments 50a-50e with respect to their neighbours in the stacking direction S. One or more of the arc segments 50a, 50c, 50e in FIG. 1c are likely to propagate further in the reverse direction R and lead to a back-ignition.

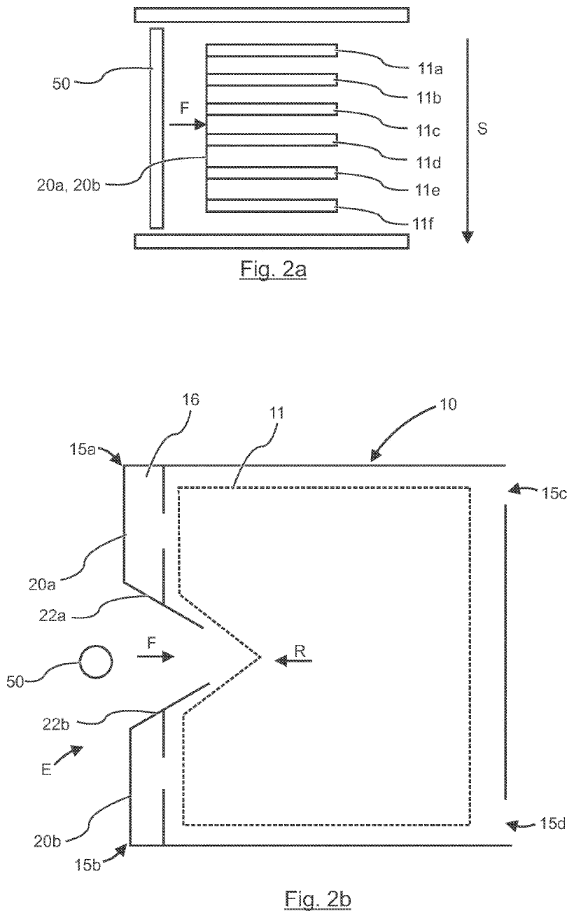

FIG. 2a shows a sectional side view of an arc chamber 10 according to an embodiment. In FIG. 2a, inhibitor barriers 20a, 20b are provided and arranged on the entry side E of the chamber 10. The spatial arrangement of the inhibitor barriers 20a, 20b relative to the plane of projection, according to the embodiment, becomes more apparent from the sectional top view of FIG. 2b which corresponds to the view of FIG. 2a.

In FIG. 2b, an arbitrary splitter plate 11 out of the plurality of splitter plates 11a-11f is shown with a dashed line. The inhibitor barriers 20a, 20b are arranged on the entry side E in such a manner that they inhibit a reverse propagation of the electric arc out of the arc chamber in the reverse direction R. In other words, the inhibitor barriers 20a, 20b are arranged such that they substantially prohibit a flow of hot gas from flowing, in the reverse direction R, beyond the entry region of the chamber 10.

It is to be noted that a reverse direction R is not necessarily an exact opposite direction of the forward direction F, but may be an oblique direction towards the entry side E, e. g. towards any one of the corner parts 15a, 15b on the entry side E of the chamber 10.

In the top view of FIG. 2b, the inhibitor barriers 20a, 20b are arranged such that a gap (i.e. a gap when seen in top view or when viewing along the stacking direction of the splitter plates) for the entry of the arc 50 is formed (i.e. formed between the inhibitor barriers 20a, 20b), when the arc 50 propagates in the forward direction F. After the entry of the arc 50 and split-up into the arc segments 50a-50e (present in FIG. 2a, as shown in FIG. 1), the arc propagates further into a central part of the chamber 10. Subsequently, there is a high likelihood for all or some of the arc segments 50a-50e to propagate into the direction of front corner parts 15a or 15b on the entry side E of the chamber 10, of rear corner parts 15c or 15d on the opposite side of the chamber 10.

Hot gas which is generated by arc segments 50a-50e, which propagate towards any of the front corner parts 15a, 15b, may result in hot conductive gas which leads to a back-ignition (a re-ignition), even after the respective arc segments 50a-50e have been extinguished.

In the embodiment of FIGS. 2a and 2b, the inhibitor barrier 20 a, 20b or inhibitor barriers 20a, 20b is or are arranged in a corner part 15a, 15b or in both corner parts 15a, 15b on the entry side E of the arc chamber 10. Any inhibitor barrier 20a, 20b serves as a protective structure around the arcing locations in the region of the front edges of the splitter plates 11a-11f, i. e. on the entry side E. The hot gas is guided away, by means of the inhibitor barrier 20a, 20b such arranged, to reduce or eliminate the probability of back-ignitions. When at least two inhibitor barriers 20a, 20b are provided, each one in a respective corner part 15a, 15b, the front corner parts 15a, 15b are shielded by the inhibitor barriers 20a, 20b, while a gap is left in between the inhibitor barriers 20a, 20b when seen in the top view.

The arc 50 or arc segments 50a-50e may first enter the splitter plate region in a substantially unobstructed manner, while a back-propagation of the arc, possibly leading to back ignitions, is effectively suppressed or prevented by the inhibitor barrier 20a, 20b. Optionally, the inhibitor barrier 20a, 20b is configured and/or arranged such that a flow of gas cannot pass in the reverse direction R beyond the entry area of the arc chamber 10 in a region where the inhibitor barriers 20a, 20b are provided. It is to be noted that the number of inhibitor barriers 20a, 20b is not limited to two.

In embodiments, the inhibitor barrier 20a, 20b extends from one outermost splitter plate 11a of the stack of splitter plates 11a-11f to the other outermost splitter plate 11f. In other words: According to this aspect, all of the spaces in between the splitter plates 11a-11f are shielded, on the entry side and in a limited region such as a respective corner region 15a, 15b when seen in the top view, by the respective inhibitor barrier 20a, 20b. The outermost splitter plates 11a, 11f are the splitter plates on the one end side and on the other end side, respectively, of the stack of splitter plates 11a-11f in the stacking direction.

According to this aspect, the inhibitor barrier 20a, 20b may be formed continuously, optionally as a continuous wall which covers the respective area at the stacked splitter plates 11a-11f as a whole. Alternatively, and still pertaining to this aspect, the inhibitor barrier 20a, 20b may be formed of a plurality of barrier segments covering less than the entirety of the respective area at the stacked splitter plates 11a-11f, while the plurality of barrier segments which form the inhibitor barriers 20a, 20b still shield all of the spaces in between the splitter plates 11a, 11f on the entry side in the respective region.

A back-propagation of the arc, possibly leading to a back-ignition, can be suppressed or prevented substantially over the entire stack of splitter plates 11a-11f, i. e. for each of the arc segments 50a-50e that move or propagate in the respective spaces.

In embodiments, the inhibitor barrier 20a, 20b is formed of a pile of inhibitor plates which are arranged in an aligned manner in the stacking direction, and each provided inhibitor plate is arranged between adjacent ones of the plurality of splitter plates 11a-11f. An inhibitor plate arranged between at least one pair of adjacent splitter plates 11a-11f abuts on both splitter plates 11a-11b, 11b-11c, etc. to effectively prevent hot gases from moving and/or penetrating in the reverse direction R beyond the front edges of the splitter plates 11a-11f the entry side E. Optionally, a respective inhibitor plate is arranged between each pair of the adjacent ones of the plurality of splitter plates 11a-11f, i. e. in each of the spaces between the splitter plates 11a-11f.

According to this aspect, the inhibitor barrier 20a, 20b is not continuous; yet, some or all of the spaces between the splitter plates 11a-11f, on the entry side and in a limited region such as a respective corner region 15a, 15b when seen in the top view, are shielded by an inhibitor plate.

The splitter plates 11a-11f which are substantially aligned in the stacking direction S form a respective inhibitor barrier 20a, 20b, which suppresses or prevents a back-propagation of an arc 50 or arc segment 50a-50e by prohibiting the hot gas generated by the arc 50 or arc segment 50a-5e from flowing back in the reverse direction, in the region, where the splitter plates 11a-11f are provided, e. g. in a corner region 15a, 15b on the entry side E.

As shown in FIG. 2b, the inhibitor barriers 20a, 20b may comprise a respective deflection section 22a, 22b which extends (i.e. when seen in the top view of the arc chamber 10) to the inside of the arc chamber 10. The deflection section or sections 22a, 22b may help to trap and deflect an arc 50 or an arc segment 50a-50e such that it does not move or propagate to the region of the gap, that is formed on the entry side in between the inhibitor barriers 20a, 20b for providing the entry of the electric arc 50 into the arc chamber 10. In the embodiment of FIGS. 2a-2b, in the rear corner parts 15c, 15d opposite to the entry side E of the chamber 10, exhaust openings are provided for releasing a flow of hot gas. A release of hot gas on the side opposite to the entry side is uncritical in view of a back-ignition or re-ignition of an arc. In embodiments, the arc chamber 10 may further comprise at least one exhaust channel 16. The exhaust channel 16 has an inlet in a region of the at least one inhibitor barrier 20a, 20b. The exhaust channel 16 extends, from the inlet, to a gas outlet. The gas outlet is formed on a side of the arc chamber 10 which is different from the entry side.

For example, the outermost splitter plate 11a in FIG. 2a is arranged on a top side of the chamber 10, the outermost splitter plate 11f in FIG. 2a is arranged on a bottom side of the chamber 10, the side having the rear corner parts 15c, 15d in FIG. 2b is the rear side of the chamber 10, and the remaining two sides other than the entry side E are a first lateral side and a second lateral side, respectively, of the chamber 10. The gas outlet may, for example, be provided in any one of the top side, the bottom side, the rear side, the first lateral side, and the second lateral side.

At least a part of the hot gas which is generated in the region, where the inlet of the exhaust channel 16 is provided, flows into the inlet, passes through the exhaust channel 16, and is eventually discharged from the chamber 10, on a side of the chamber 10 which is different from the entry slide. Thus, less hot gas will back-propagate in the direction of the entry side, and a probability of a back-ignition can be further reduced.

In embodiments, a DC circuit breaker (not shown) having an arcing contact arrangement is provided with an arc chamber 10 as described herein. In the DC circuit breaker, upon a contact opening operation, an electric arc is generated, which is received on the entry side E of the arc chamber 10 and propagates in a forward direction into the region of the stacked splitter plates. The at least one inhibitor barrier arranged on the entry side E is configured such as to inhibit a reverse propagation of the arc out of the arc chamber 10 in the reverse direction R. It is noted that also in the DC circuit breaker provided with the arc chamber 10, some or all of the aspects as described herein may be implemented and/or freely combined with each other, as appropriate.

In embodiments, an arc chamber 10, as described herein, is used with a circuit breaker in a DC electrical system. It is noted that also in the use of the arc chamber 10 with a circuit breaker in a DC electrical system, some or all of the aspects as described herein may be implemented and/or freely combined with each other, as appropriate,

1-12. (canceled)

13. An arc chamber for a DC circuit breaker, comprising:
an entry side adapted to receive an electric arc which was generated outside of the arc chamber and which propagates in a forward direction;
a plurality of stacked splitter plates;
at least one inhibitor barrier arranged on the entry side to inhibit a reverse propagation of the electric arc out of the arc chamber in a reverse direction.

14. The arc chamber according to claim 13,
wherein, in a top view of the arc chamber, the at least one inhibitor barrier is arranged in a corner part on the entry side of the arc chamber.

15. The arc chamber according to claim 13,
wherein the arc chamber comprises at least two inhibitor barriers, each arranged, in a top view of the arc chamber, in opposite corner parts on the entry side of the arc chamber.

16. The arc chamber according to claim 14,
wherein the arc chamber comprises at least two inhibitor barriers, each arranged, in the top view of the arc chamber, in opposite corner parts on the entry side of the arc chamber.

17. The arc chamber according to claim 13,
wherein, in a top view of the arc chamber, at least two inhibitor barriers are spaced apart from one another, such that a gap for the entry of the electric arc is formed on the entry side.

18. The arc chamber according to claim 17,
wherein, in the top view of the arc chamber, the at least two inhibitor barriers are spaced apart from one another, such that a gap for the entry of the electric arc is formed on the entry side.

19. The arc chamber according to claim 13,
wherein, the inhibitor barriers comprise at least one deflection section which extends to the inside of the arc chamber, in the case wherein the at least one deflection selection is defined by one deflection section, the deflection section is designed for trapping and deflecting the arc or an arc segment such that it does not propagate back to the region of the gap, and wherein, in the case wherein the at least one deflection selection is defined by more than one deflection section, the deflection sections are designed for trapping and deflecting the arc or an arc segment such that it does not propagate back to the region of the gap, the gap being formed on the entry side in between the inhibitor barriers for the entry of the electric arc.

20. The arc chamber according to claim 13,
wherein the at least one inhibitor barrier extends substantially in a stacking direction of the splitter plates.

21. The arc chamber according to claim 20,
wherein the at least one inhibitor barrier continuously extends in the stacking direction of the splitter plates essentially from one outermost splitter plate to the other outmost splitter plate of the plurality of stacked splitter plates.

22. The arc chamber according to claim 16,
wherein the at least two inhibitor barriers each extend substantially in a stacking direction of the splitter plates.

23. The arc chamber according to claim 22,
wherein the at least two inhibitor barriers each continuously extend in the stacking direction of the splitter plates essentially from one outermost splitter plate to the other outermost splitter plate of the plurality of stacked splitter plates.

24. The arc chamber according to claim 20,
wherein the at least one inhibitor barrier is formed of a pile of inhibitor plates, which are arranged in an aligned manner in the stacking direction, wherein each inhibitor plate is provided between adjacent splitter plates of the plurality of splitter plates.

25. The arc chamber according to claim 24,
wherein a respective inhibitor plate is provided between each pair of adjacent splitter plates of the plurality of splitter plates.

26. The arc chamber according to claim 22,
wherein the at least two inhibitor barriers are each formed of a pile of inhibitor plates which are arranged in an aligned manner in the stacking direction, wherein each inhibitor plate is provided between adjacent splitter plates of the plurality of splitter plates.

27. The arc chamber according to claim 26,
wherein a respective inhibitor plate is provided between each pair of adjacent splitter plates of the plurality of splitter plates.

28. The arc chamber according to claim 13, further comprising:
an inlet of an exhaust channel in a region of the at least one inhibitor barrier, wherein the exhaust channel extends to a gas outlet formed on a side of the arc chamber different from the entry side.

29. The arc chamber according to claim 24, further comprising:
an inlet of an exhaust channel in a region of the at least one inhibitor barrier, wherein the exhaust channel extends to a gas outlet formed on a side of the arc chamber different from the entry side.

30. The arc chamber according to claim 26, further comprising:
an inlet of an exhaust channel in a region of the at least two inhibitor barriers, wherein the exhaust channel extends to a gas outlet formed on a side of the arc chamber different from the entry side.

31. A DC circuit breaker comprising an arc chamber according to claim 13.
